(19) United States
(12) Patent Application Publication
(10) Pub. No.: US 2010/0289781 A1
(43) Pub. Date: Nov. 18, 2010

(54) DISPLAY APPARATUS

(75) Inventors: Sung-soo KIM, Suwon-si (KR); Kab-keun LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/695,295

(22) Filed: Jan. 28, 2010

(30) Foreign Application Priority Data
May 14, 2009 (KR) 10-2009-0042186

(51) Int. Cl. G06F 3/038

(52) U.S. Cl. 345/206; 345/213

(57) ABSTRACT

A display apparatus is provided in which an image processing unit and a timing control unit are disposed on a single board, and in which a compensation unit and a converter unit are disposed in a driving unit, the compensation unit compensating distortion of a signal, and the converter unit converting an interface. Accordingly, a manufacturer of the display apparatus can dispose a timing control IC on an image board and eliminate a timing control board.

### CROSS-REFERENCE TO RELATED APPLICATIONS

This application claims priority from Korean Patent Application No. 10-2009-0042186, filed on May 14, 2009 in the Korean Intellectual Property Office, the disclosure of which is incorporated herein by reference in its entirety.

### BACKGROUND OF THE INVENTION

1. Field of the Invention

Apparatuses and methods consistent with the present invention relate to a display apparatus, and more particularly, to a display apparatus in which a timing control unit and an image processing unit are disposed in the same board.

2. Description of the Related Art

FIG. 5 illustrates a configuration of a conventional display apparatus. In general, a display apparatus includes an image board 510, a timing control board 520, and a driving unit 530. The timing control board 520 includes a reduced swing differential signaling (RSDS) output connector 521, a GMA voltage (VGMA) 522, a timing control integrated circuit (IC) 523, a common voltage (VCOM) 524, a direct current/direct current (DC/DC) unit 525, and low-voltage differential signaling (LVDS) input connector 526.

The LVDS input connector 526 receives an image signal from the image board 510 through an LVDS interface. The timing control IC 523 generates a driving control signal corresponding to the image signal. The RSDS output connector 521 outputs the driving control signal to the driving unit 530 through an RSDS interface.

The VGMA 522 generates gamma power to be used in a display panel and the driving unit 530. The VCOM 524 controls common power. The DC/DC unit 525 generates power consisting of a DC/DC and a low drop-out (LDO) which are used in the timing control board 520, the driving unit 530, and the display panel.

The input image signal is processed by the image board 510, and transmitted to the timing control board 520. The timing control board 520 generates a driving control signal corresponding to the image signal input from the image board 510, and transmits the driving control signal to the driving unit 530. The driving unit 530 drives the display panel according to the driving control signal.

As described above, the conventional display apparatus has the timing control board 520. However, if the display apparatus separately has the timing control board 520, a cost of the display apparatus is increased. However, if the timing control board 520 is eliminated from the display apparatus, image degradation is caused due to a transmission distance between the image board 510 and the driving unit 530. In particular, there is some trouble to eliminate a timing control board from a display apparatus having a large screen due to a long transmission distance between the image board 510 and the driving unit 530.

In addition, since display panels use different interfaces according to the manufacturer, there is inconvenience that timing control boards have to be manufactured to be suitable for the manufacturer of display panels.

Therefore, there is a need for methods for disposing a timing control IC on the image board 510 and eliminating the timing control board 520.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention provides a display apparatus in which an image processing unit and a timing control unit are disposed on a single board, and in which a compensation unit and a converter unit are disposed in a driving unit, the compensation unit compensating distortion of a signal, and the converter unit converting an interface.

According to an exemplary aspect of the present invention, there is provided a display apparatus, including an image processing unit which is disposed on a first board and processes an input image signal, a timing control unit which is disposed on the first board together with the image processing unit and generates a driving control signal corresponding to the processed image signal, a driving unit which comprises a second board and drives a display panel according to the driving control signal, and a converter unit which is disposed on the second board and converts an interface of the driving control signal output by the timing control unit and transmits the converted driving control signal to the driving unit.

The display apparatus may further include a compensation unit which is disposed on the second board and compensates distortion of the driving control signal which is caused due to a cable greater than a predetermined length, wherein the timing control unit is connected to the driving unit through the cable greater than the predetermined length, and the predetermined length is a threshold length at which distortion of the driving control signal may occur.

The converter unit and the compensation unit may be disposed on a single integrated circuit (IC).

The IC may be a bridge IC.

The compensation unit may compensate distortion of the driving control signal using at least one of an equalizer, pre-emphasis, and signal restoration.

The timing control unit may transmit the driving control signal to the driving unit using one interface from among reduced swing differential signaling (RSDS), Mini-low-voltage differential signaling (Mini-LVDS), point to point differential signaling (PPDS), LVDS, advanced intra-panel interface (AiPi), and V-by-One (V×1), and the converter unit may convert the driving control signal into another interface from among reduced swing differential signaling (RSDS), Mini-low-voltage differential signaling (Mini-LVDS), point to point differential signaling (PPDS), LVDS, advanced intra-panel interface (AiPi), and V×1.

The image processing unit and the timing control unit may be mounted on the first board as separate chips.

The image processing unit and the timing control unit may be mounted on the first board as a single chips.

The first board may be an image board.

The second board may be a source printed board assembly (PBA) board.

The timing control unit may be a timing control integrated circuit (IC).

In an exemplary embodiment of the invention, there is a display apparatus including: a first board including an image processor which processes an input image signal to output an RGB signal and a control signal and a timing unit which processes the RGB signal to generate a data signal and to generate driving signals from the control signal; and a second board including a circuit which converts an interface of the driving signal; and a driving unit which drives a display panel according to the interface converted driving signal, wherein the first board is not in contact with the second board.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a detailed configuration of a display apparatus according to an exemplary embodiment of the present invention;

FIGS. 2A to 2C illustrate various dispositions of a VGMA, a VCOM, and a DC/DC unit according to an exemplary embodiment of the present invention;

FIG. 3 illustrates an example of a bridge IC according to an exemplary embodiment of the present invention;

FIG. 4A illustrates a driving control signal generated by a timing control unit according to an exemplary embodiment of the present invention;

FIG. 4B illustrates a driving signal output by a source driving unit when there is no bridge IC according to an exemplary embodiment of the present invention;

FIG. 4C illustrates a driving signal which is output by a source driving unit after being compensated by a bridge IC according to an exemplary embodiment of the present invention; and

FIG. 5 illustrates a configuration of a conventional display apparatus.

### DETAILED DESCRIPTION OF EXEMPLARY EMBODIMENTS OF THE INVENTION

Certain exemplary embodiments of the present invention will now be described in greater detail with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail. Expression such as “at least one of,” when preceding a list of elements, modifies the entire list of elements and does not modify each element of the list.

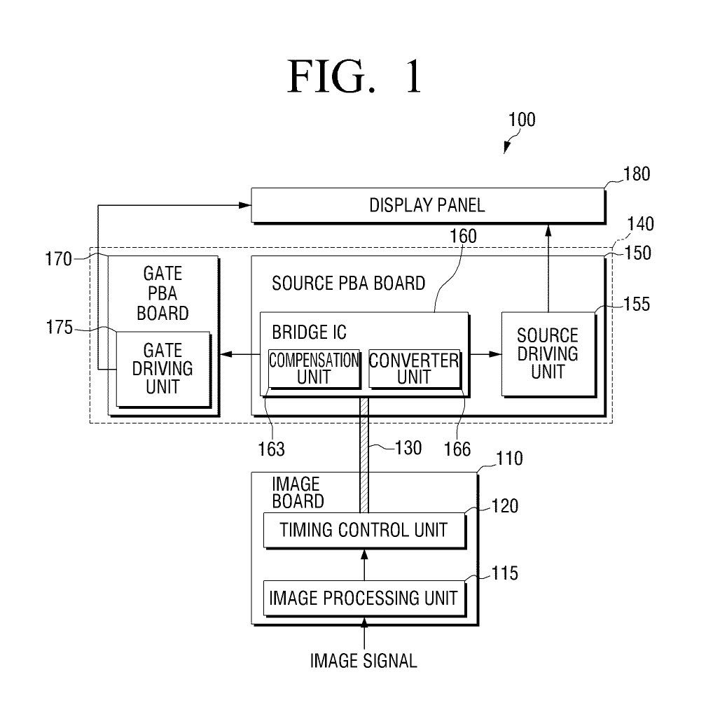

FIG. 1 is a block diagram illustrating a detailed configuration of a display apparatus according to an exemplary embodiment of the present invention. As illustrated in FIG. 1, the display apparatus 100 may include an image board 110, a cable 130, e.g., a conductor wire, a driving unit 140, and a display panel 180.

On the image board 110, an image processing unit 115 and a timing control unit 120 are disposed together. That is, the display apparatus 100 does not have a separate timing control board, but instead the timing control unit 120 is disposed on the image board 110.

On the image board 110, circuits or chips to control image processing and displaying are disposed.

The image processing unit 115 is disposed on the image board 110 and processes an input native image signal. For example, the image processing unit 115 processes the input native image signal so that a red-green-black (RGB) image signal and an input control signal are generated. The input control signal may include a data enable (DE) signal, a horizontal sync (Hsync) signal, a vertical sync (Vsync) signal, and main clock (MCLK) signal. The image processing unit 115 transmits the processed image signal to the timing control unit 120.

For example, the frequency of a Vsync signal of a display apparatus applied to a television application is approximately 60 Hz in National Television System Committee (NTSC) method, and is approximately 50 Hz in Phase Alternation Line (PAL). Furthermore, the frequency of a Hsync signal is approximately 48 KHz in a high definition (HD) level, and is approximately 67 KHz in a Full HD level.

The timing control unit 120 is disposed on the image board 110, and generates a driving control signal corresponding to the processed image signal. That is, the timing control unit 120 controls operation of the display panel 180 and a backlight (not shown) using the driving control signal.

More specifically, the timing control unit 120 processes an input RGB image signal so as to generate a data signal. In addition, the timing control unit 120 processes an input control signal so as to generate a gate driving control signal and a source driving control signal. That is, the driving control signal includes a data signal, a gate driving control signal, and a source driving control signal. The timing control unit 120 transmits the data signal and the source driving control signal to the source driving unit 155 through the bridge IC 160, and transmits the gate driving control signal to the gate driving unit 175.

The timing control unit 120 transmits the driving control signal to the bridge IC 160 of the driving unit 140 through the cable 130 using an interface such as reduced swing differential signaling (RSDS), Mini-low-voltage differential signaling (Mini-LVDS), point to point differential signaling (PPDS), LVDS, advanced intra-panel interface (AiPi), or V×1.

The timing control unit 120 may be disposed on the image board 110 as a chip separate from the image processing unit 115. That is, the timing control unit 120 may be implemented with a timing control IC chip, and the image processing unit 115 may be implemented with an image processing IC chip. However, the timing control unit 120 may be disposed on the image board 110 together with the image processing unit 115 as a single chip.

The cable 130 electrically connects the timing control unit 120 to the bridge IC 160 in the driving unit 140. The mage board 110 and the driving unit 140 are spaced a predetermined distance apart from each other in the display apparatus 100 for the reason of disposition of hardware. As the screen of the display apparatus 100 is larger, a distance between the mage board 110 and the driving unit 140 is farther. Accordingly, the cable 130 electrically connects the image board 110 to the driving unit 140.

However, if the cable 130 is longer than a predetermined length, distortion of a driving control signal is caused. Noise is generated while the driving control signal is passing through the cable 130, so if the cable 130 is longer, distortion of the driving control signal is more severe. The predetermined length is a threshold length at which distortion of the driving control signal which may cause image degradation.

The driving unit 140 drives the display panel 180 according to the driving control signal, and includes a source printed board assembly (PBA) board 150 and a gate printed board assembly (PBA) board 170.

The source PBA board 150 includes the source driving unit 155 and the bridge IC 160.

The source driving unit 155 converts the data signal transmitted from the timing control unit 120 through the bridge IC 160 into an analog signal, and outputs the analog signal to data lines. The source driving unit 155 includes a plurality of source driving ICs.

The bridge IC 160 converts an interface of the driving control signal output by the timing control unit 120, compensates distortion of the driving control signal, and transmits the converted and compensated driving control signal to the source driving unit 155 and the gate driving unit 175. As illustrated in FIG. 1, the bridge IC 160 includes a compensation unit 163 and a converter unit 166.

The compensation unit 163 compensates distortion of the driving control signal which is caused by the cable 130 between the timing control unit 120 and the bridge IC 160. More specifically, the compensation unit 163 compensates distortion of the driving control signal using at least one of an equalizer, pre-emphasis, and signal restoration. Since the driving control signal generates various noise while passing through the cable 130 having the predetermined length, the compensation unit 163 removes the noise so that distortion of the driving control signal can be compensated.

The converter unit 166 converts the interface of the driving control signal output by the timing control unit 120 into an interface which is suitable for the display panel 180. The driving control signal is input from the timing control unit 120 to the bridge IC 160 through one of interfaces such as RSDS, Mini-LVDS, PPDS, LVDS, AiPi, and V×1. The display panel 180 is driven by a driving signal of one of interfaces such as RSDS, Mini-LVDS, PPDS, LVDS, AiPi, and V×1. In order for the driving control signal to be suitable for the display panel 180, the converter unit 166 converts the interface of the driving control signal into one of interfaces such as RSDS, Mini-LVDS, PPDS, LVDS, AiPi, and V×1.

The converter unit 166 may directly determine the type of interface of the driving control signal input by the timing control unit 120 or the type of interface to be output to the display panel 180. For example, the converter unit 166 may receive a reference voltage from the timing control unit 120 and determine the type of interface of the driving control signal using the reference voltage. In addition, the converter unit 166 may receive a reference voltage from the display panel 180 and determine the type of interface of the driving control signal using the reference voltage.

In addition, the type of interface of the driving control signal input by the timing control unit 120 or the type of interface to be output to the display panel 180 may be set by the manufacturer.

The gate PBA board 170 includes the gate driving unit 175, and the gate driving unit 175 includes a plurality of gate driving ICs.

The gate driving unit 175 receives the compensated and converted gate driving control signal from the bridge IC 160, and drives gate lines.

The display panel 180 is driven by the driving unit 140 and displays an image corresponding to the input image signal. More specifically, the display panel 180 includes an array substrate on which alternately disposed gate lines and a plurality of sub pixels defined by the data lines are formed, and an opposed substrate which is connected to the array substrate so as to contain a liquid crystal layer. In the sub pixels, a thin film transistor (TFT), which is a switching element which is connected to the gate lines and the data lines, a liquid crystal capacitor (CLC), which is connected to the TFT, and a storage capacitor (CST) are formed.

In the display panel 180, a gate voltage is transmitted to the gate lines, so the TFT is turned on. A data voltage transmitted to the data lines is transmitted to the CLC. Accordingly, a light penetrating rate of the CLC can be adjusted and the display panel 180 can display an image.

The bridge IC 160 including the compensation unit 163 and the converter unit 166 is disposed on a source PBA board 150 in the driving unit 140, and thus can compensate distortion of the driving control signal and converts the interface. Consequently, even if the display apparatus 100 does not include a timing control board, the display apparatus 100 can provide an image having no distortion. In addition, since the bridge IC 160 converts an interface of the driving control signal output by the timing control unit 120 into an interface suitable for the display panel 180, the manufacturer can mount display panels 180 of various manufactures on one type of image board 110 to manufacture the display apparatus 100.

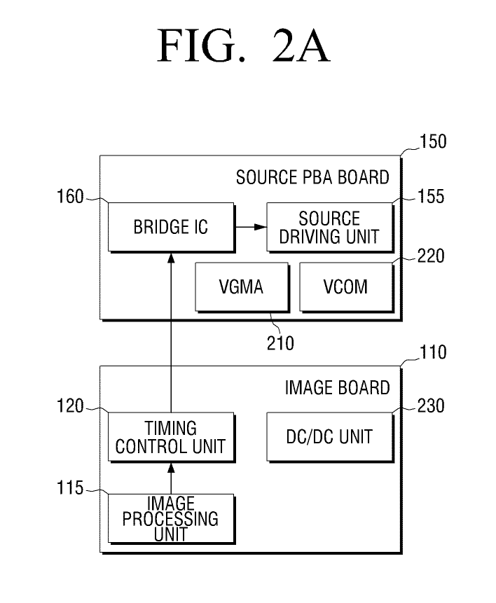

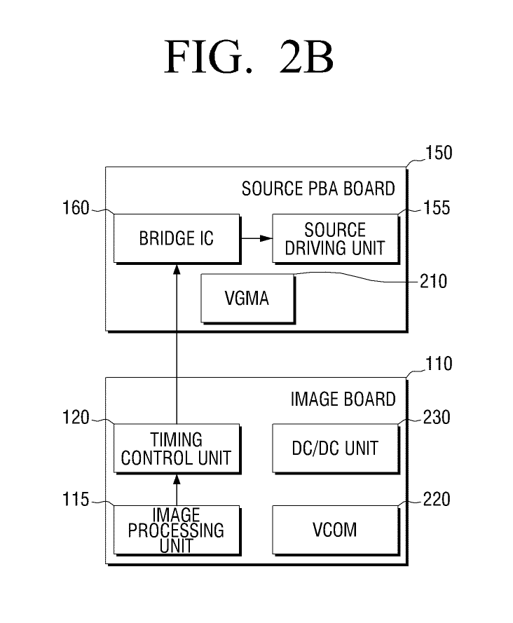

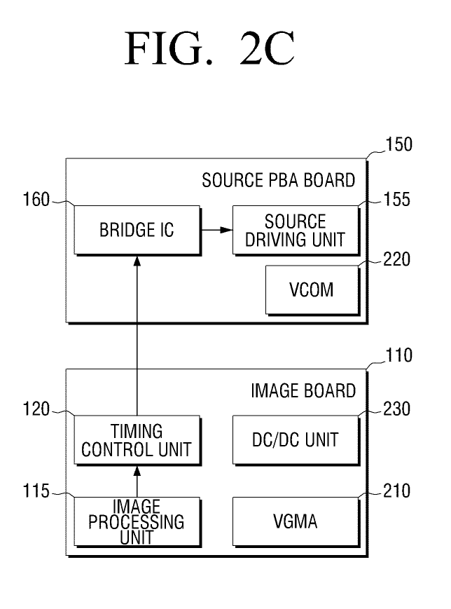

Hereinafter, when a timing control board is eliminated, disposition of the components of the timing control board is described with reference to FIGS. 2A to 2C. FIGS. 2A to 2C illustrate various dispositions of a VGMA 210, a VCOM 220, and a DC/DC unit 230 according to an exemplary embodiment of the present invention.

A conventional timing control board includes the VGMA 210, the VCOM 220, and the DC/DC unit 230 as well as the timing control unit 120. Accordingly, if the timing control board is eliminated, the VGMA 210, the VCOM 220, and the DC/DC unit 230 have to be appropriately disposed on the source PBA board 150 and the image board 110. Since the DC/DC unit 230 has to supply power to the timing control unit 120, the DC/DC unit 230 is disposed on the image board 110 together with the timing control unit 120. Accordingly, the VGMA 210 and the VCOM 220 have to be appropriately disposed on the source PBA board 150 and the image board 110.

As illustrated in FIG. 2A, both the VGMA 210 and the VCOM 220 can be disposed on the source PBA board 150. As illustrated in FIG. 2B, both the VGMA 210 can be disposed on the source PBA board 150 and the VCOM 220 can be disposed on the image board 110. As illustrated in FIG. 2C, both the VGMA 210 and the VCOM 220 can be disposed on the image board 110.

As described above, the VGMA 210 and the VCOM 220 can be disposed in various forms.

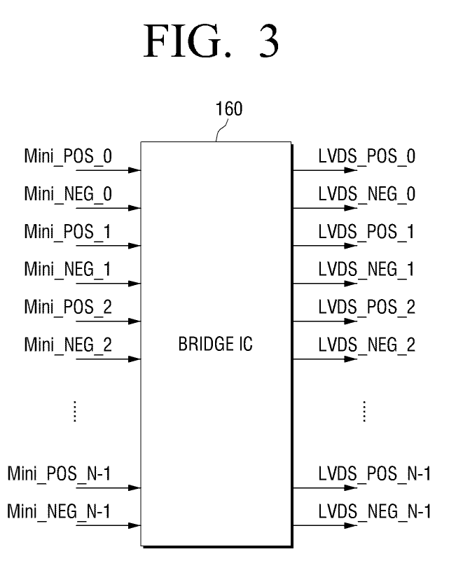

FIG. 3 illustrates an example of the bridge IC 160 according to an exemplary embodiment of the present invention. As illustrated in FIG. 3, in the bridge IC 160, an interface of an input signal is different from an interface of an output signal. In FIG. 3, the bridge IC 160 converts a signal input using Mini-LVDS into a signal using LVDS. In addition, the bridge IC 160 can perform interface conversion of various other combinations.

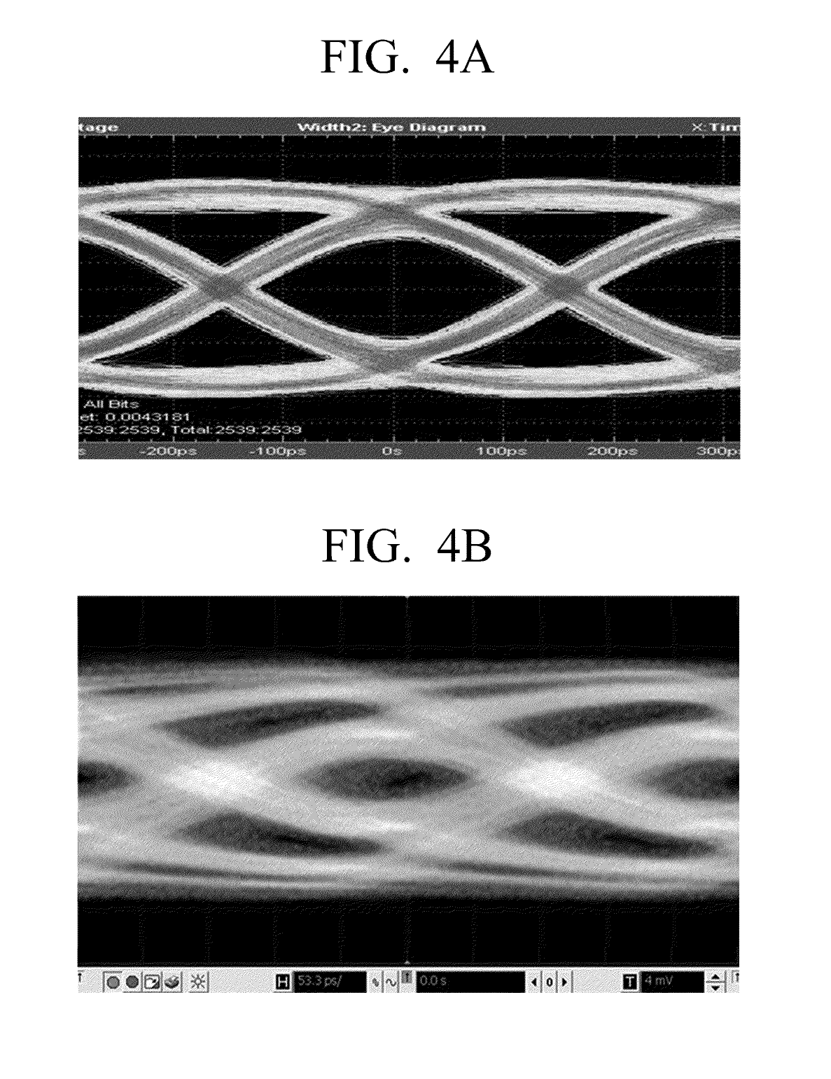

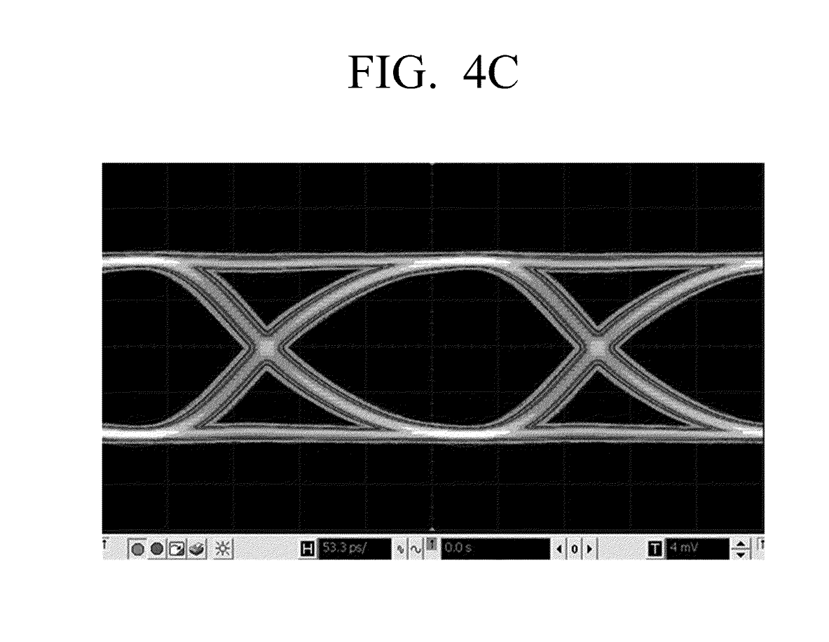

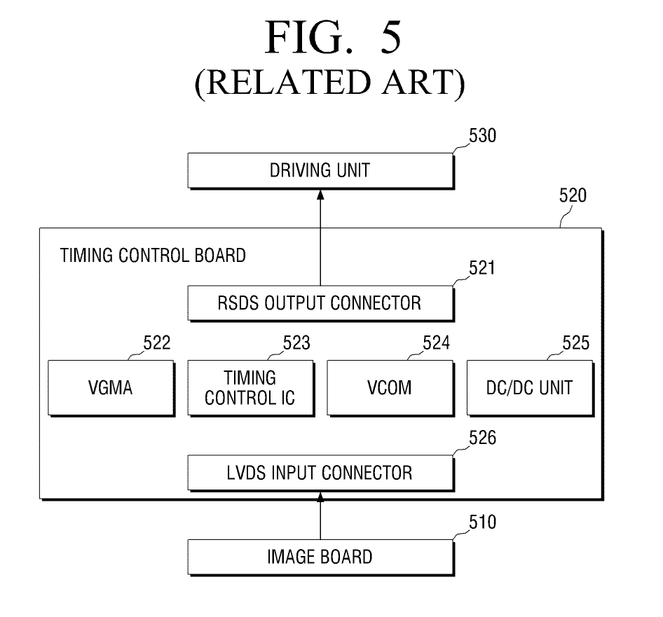

Hereinafter, the degree of degradation of a driving signal according to presence or absence of the bridge IC 160 is described with reference to FIGS. 4A to 4C.

FIG. 4A illustrates a driving control signal generated by the timing control unit 120 according to an exemplary embodiment of the present invention.

FIG. 4B illustrates a driving signal output by the source driving unit 155 when there is no bridge IC according to an exemplary embodiment of the present invention. As illustrated in FIG. 4B, the driving signal is severely distorted after passing through the cable 130.

FIG. 4C illustrates a driving signal which is output by the source driving unit 155 after being compensated by the bridge IC 160 according to an exemplary embodiment of the present invention. As illustrated in FIG. 4C, if the driving signal is compensated by the bridge IC 160, the driving signal output by the source driving unit 155 is similar to the driving control signal generated by the timing control unit 120.

As described above, if the display apparatus 100 has the bridge IC 160, the bridge IC 160 can compensate distortion of the driving control signal caused due to a long distance between the timing control unit 120 and the driving unit 140, and prevent image degradation.

In the exemplary embodiment of the present invention, the bridge IC 160 is disposed on the source PBA board 150. However, the bridge IC 160 may be disposed on any component in the driving unit 140. For example, the bridge IC 160 may be disposed on the PBA board 170 in the driving unit 140.

As can be appreciated from the above description, a display apparatus is provided in which an image processing unit and a timing control unit are disposed on a single board, and in which a compensation unit and a converter unit are disposed in a driving unit, the compensation unit compensating distortion of a signal, and the converter unit converting an interface. Accordingly, a timing control IC is disposed on an image board, so a timing control board is not needed. Consequently, the manufacturing costs of the display apparatus can be decreased, image degradation can be prevented, and panels of various manufactures can be mounted in the display apparatus.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
an image processing unit which is disposed on a first board and processes an input image signal;
a timing control unit which is disposed on the first board and generates a driving control signal corresponding to the processed image signal;
a driving unit which comprises a second board and drives a display panel according to the driving control signal; and
a converter unit which is disposed on the second board and converts an interface of the driving control signal output by the timing control unit and transmits the converted driving control signal to the driving unit.

2. The display apparatus according to claim 1, further comprising:
a compensation unit which is disposed on the second board and compensates distortion of the driving control signal which is caused due to a cable greater than a predetermined length,
wherein the timing control unit is connected to the driving unit through the cable greater than the predetermined length.

3. The display apparatus according to claim 2, wherein the converter unit and the compensation unit are disposed on a single integrated circuit (IC).

4. The display apparatus according to claim 3, wherein the single IC is a bridge IC.

5. The display apparatus according to claim 2, wherein the compensation unit compensates the distortion of the driving control signal using at least one of an equalizer, pre-emphasis, and signal restoration.

6. The display apparatus according to claim 1, wherein the timing control unit transmits the driving control signal to the driving unit using one interface from among reduced swing differential signaling (RSDS), Mini-low-voltage differential signaling (Mini-LVDS), point to point differential signaling (PPDS), LVDS, advanced intra-panel interface (AiPi), and V-by-One (V×1), and
the converter unit converts the driving control signal into another interface from among RSDS, Mini-LVDS, PPDS, LVDS, AiPi, and V×1.

7. The display apparatus according to claim 1, wherein the image processing unit and the timing control unit are mounted on the first board as separate chips.

8. The display apparatus according to claim 1, wherein the image processing unit and the timing control unit are mounted on the first board as a single chip.

9. The display apparatus according to claim 1, wherein the first board is an image board.

10. The display apparatus according to claim 1, wherein the second board is a source printed board assembly (PBA) board.

11. The display apparatus according to claim 1, wherein the timing control unit is a timing control integrated circuit (IC).

12. A display apparatus comprising:
a first board comprising:
an image processor which processes an input image signal to output an RGB signal and a control signal; and
a timing unit which processes the RGB signal to generate a data signal and to generate driving signals from the control signal, and
a second board comprising:
a circuit which converts an interface of the driving signal; and
a driving unit which drives a display panel according to the interface converted driving signal,
wherein the first board is not in contact with the second board.

13. The display apparatus of claim 12, wherein the data signal and the driving signals are output from the first board to the second board via a conductor wire, and the circuit of the second board comprises a converter unit to covert the interface and a compensation unit which substantially removes noise from the driving signals, caused by the conductor wire.

14. The display apparatus of claim 13, wherein the circuit is a bridge integrated circuit.

15. The display apparatus of claim 14, wherein the compensation unit substantially removes the noise using at least one of an equalizer, pre-emphasis, and signal restoration.
